(19) United States
(12) Patent Application Publication
(10) Pub. No.: US 2021/0366268 A1
(43) Pub. Date: Nov. 25, 2021

(54) AUTOMATIC TUNING OF INCIDENT NOISE

(71) Applicant: Microsoft Technology Licensing, LLC, Redmond, WA (US)

(72) Inventors: Navendu Jain, Snohomish, WA (US); Mary Arpita Pyreddy, Redmond, WA (US)

(21) Appl. No.: 16/880,573

(22) Filed: May 21, 2020

(51) Int. Cl. G08B 31/00; G08B 29/18

(52) U.S. Cl. CPC G08B 31/00; G08B 29/185

(57) ABSTRACT

Methods, systems, and computer program products are provided for identifying configuration parameters for generating issues in a computing environment. A data retriever is configured to retrieve, from a data store, past incident data relating to past alerts in the computing environment. A configuration optimizer generates a configuration change based at least on an evaluation of the past incident data. For instance, the configuration change can be a recommended change to one or more configuration settings of a monitoring system and/or an incident management system. An incident volume change is predicted under an assumption the configuration change is implemented. Based at least on the incident volume change, the configuration change can be provided for implementation on an alerting system.

### BACKGROUND

Incident management systems provide industry professionals with an interface for receiving and responding to incidents. For instance, in an information technology (IT) setting, engineers may receive reports corresponding to a wide range of activities occurring on various systems connected on a cloud-computing network. Responding to each incident in a timely manner is critical since certain incidents may be critical to the operation of one or more systems on the network and/or impact a customer. When an engineer receives an incident report through an incident management system, the engineer may need to perform a set of tasks in responding to the incident. For example, an engineer may need to acknowledge the incident, transfer the incident to another group responsible for responding to the incident, perform steps to mitigate the incident, and/or resolve the incident. As a result, continuous tracking of the health of cloud-based services becomes important, as well as responding to any issues that may arise.

However, in many instances, incidents created for resolution may be generated unnecessarily. For instance, incidents can be generated where thresholds for monitoring various types of signals (e.g., temperature, computing activity, networking activity, etc.) may not have been appropriately set, thereby leading to false positives. When such incidents are generated, human intervention may be required to resolve the incident, which can utilize valuable engineer resources, and reduce the amount of time available to address other issues that could be more problematic.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for identifying configuration parameters for generating issues in a computing environment. A data retriever is configured to retrieve, from a data store, past incident data relating to past alerts in the computing environment. A configuration optimizer generates a configuration change based at least on an evaluation of the past incident data. For instance, the configuration change can be a recommended change to one or more configuration settings of a monitoring system and/or an incident management system. An incident volume change is predicted under an assumption the configuration change is implemented. Based at least on the incident volume change, the configuration change can be provided for implementation on an alerting system.

In this manner, the change in volume due to implementation of a configuration change in an alerting system can be predicted before the change is implemented, thereby enabling optimization of the configuration settings in the alerting system. For example, if a particular configuration change is predicted to reduce an overall number of incidents generated by the incident management system, the configuration change may be provided for implementation on the appropriate system (e.g., the monitoring system, a correlation engine, etc.), thereby reducing the number of the incidents generated for resolution.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for identifying configuration parameters for generating issues in a computing environment, in accordance with an example embodiment.

FIG. 2 shows a flowchart of a method for identifying configuration parameters for generating issues in a computing environment, in accordance with an example embodiment.

FIG. 3 shows a block diagram of a system for reducing incident noise in a computing environment, in accordance with an example embodiment.

FIG. 4 shows a flowchart of a method for simulating a correlation of past alerts, in accordance with an example embodiment.

FIG. 5 shows a flowchart of a method for providing an insight associated with a predicted incident volume change, in accordance with an example embodiment.

FIG. 6 shows a block diagram of an illustrative system that may implement configuration changes, in accordance with an example embodiment.

FIG. 7 shows an illustrative user interface depicting a set of configuration parameters in a monitoring system, in accordance with an example embodiment.

FIG. 8 shows an illustrative user interface depicting a set of configuration parameters in an incident management system, in accordance with an example embodiment.

FIG. 9 shows a block diagram of a system that may be used to implement example embodiments described herein.

FIG. 10 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous example embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As cloud services continue to grow in scale and complexity, cloud operators must cope with managing a large number of physical resources (e.g., servers, storage, networking) and virtual resources (e.g., virtual machines, cloud-based apps, mobile applications). Further, modern computing frameworks such as microservices and containers have increased fragmentation in cloud infrastructures. In addition, adoption of an agile development model for service release cycles is growing rapidly in order to quickly deliver new features and bug fixes to users. These trends have caused orders of magnitude increase in the monitoring data generated from run-time operations—orders of hundreds of thousands per month.

In many cloud services, a large fraction of incidents are created by automated monitoring services. These incidents are typically created from alerts when a threshold defined in the monitors is crossed. When incidents are created, engineers may receive reports corresponding to the issues that need to be resolved. Responding to each incident in a timely manner is critical since certain incidents may be critical to the operation of one or more systems on the network and/or impact a customer. When an engineer receives an incident report through an incident management system, the engineer may need to perform a set of tasks in responding to the incident. For example, an engineer may need to acknowledge the incident, transfer the incident to another group responsible for responding to the incident, perform steps to mitigate the incident, and/or resolve the incident. As a result, continuous tracking of the health of cloud-based services becomes important, as well as responding to any issues that may arise.

The increasing magnitude of alerts, however, poses a challenge for service engineers and operators responsible for handling those alerts. Each time an issue occurs, service teams may receive a flood of alerts from multiple monitoring tools but without sufficient context as to the underlying problem. Thus, identifying the source of the problem becomes difficult when engineers' workloads are already full. As a result, delayed time to resolve incidents may occur, leading to extended service downtime and customer impact. In addition, other important issues may be missed or further delayed due to such high volumes of alerts.

In many instances, incidents created for resolution may be generated unnecessarily for incidents that are noise or non-actionable. For instance, incidents can be generated where thresholds for monitoring various types of signals (e.g., temperature, computing activity, networking activity, etc.) may not have been appropriately set, thereby leading to false positives. This may occur, for instance, during the initial creation or setup of a monitor (such as when a new service is being monitored) but detailed understanding of the actual runtime behavior of the service is lacking. In these situations, on-call engineers may receive a large fraction of incidents, only to realize such incidents were noise after expending time and effort to resolve them. Thus, when such noisy incidents are generated, not only is human intervention typically required to resolve the incident, which can utilize valuable engineer resources, the amount of time available to address other actionable issues waiting in a queue that could be more problematic is also reduced. Thus, when monitors and correlation rules are not properly configured to only output actionable incidents, the number of noisy incidents can be burdensome.

Embodiments described herein address these issues by identifying configuration parameters for generating issues in a computing environment. A data retriever is configured to retrieve, from a data store, past incident data relating to past alerts in the computing environment. A configuration optimizer generates a configuration change based at least on an evaluation of the past incident data. For instance, the configuration change can be a recommended change to one or more configuration settings of a monitoring system and/or an incident management system. An incident volume change is predicted under an assumption the configuration change is implemented. Based at least on the incident volume change, the configuration change can be provided for implementation on an alerting system. In this manner, potential changes to an alerting system (e.g., a monitoring system, incident management system, etc.) may be evaluated before applying the changes, thereby improving the likelihood that the changes, if implemented, would result in a desired volume change (e.g., a reduction in noisy incidents).

This approach has numerous advantages, including but not limited to reducing the number of incidents needed to be resolved in an incident management system, thereby reducing the overall amount of engineer resources expended to resolve the incidents and enabling those preserved resources to be used for resolving other more important incidents. For instance, by reducing noisy incidents and improving overall productivity, incidents arising relating to resources that are being monitored, such as applications, services, etc., may be resolved quicker and more accurately, thereby leading to a reduction in downtime and overall improved performance of those resources.

Furthermore, by reducing the number of incidents in an alerting system, such as an incident management system, resources utilized by computing devices that implement such systems will be also be reduced. For example, optimizing configuration parameters as described herein may decrease the number of generated incidents, which results in less storage resources utilized to store the incidents (and data associated with each incident). Further, less processing resources may be required at such systems. For example, since a reduced number of resources are being generated, correlation engines that combine different incidents together may operate more efficiently due to the overall reduction in incident volume. Furthermore, a reduction in incident volume may also reduce the number of engineers needed to resolve generated incidents, thereby reducing the processing and networking overhead associated with each engineer's access to such systems to review and resolve incidents. In addition, where configuration parameters are also implemented in other alerting systems, such as monitoring systems, to reduce the number of alerts generated by the monitors, the reduction in alerts can similarly preserve processing and/or storage resources at computing devices implementing those monitors, as well as reducing the network resources utilized between each of the monitoring system and incident management systems (e.g., by reducing the overall number of alerts that are communicated from the monitoring systems to the incident management systems).

Accordingly, example implementations are described for a systematic and data-driven approach to optimally generate, simulate, and/or recommend configuration changes (e.g., monitoring changes and/or correlation rule changes) to change an amount of incident noise that may be generated. Example implementations described herein to automatically tune incident noise include various configuration change types such that techniques may be applied across different domains.

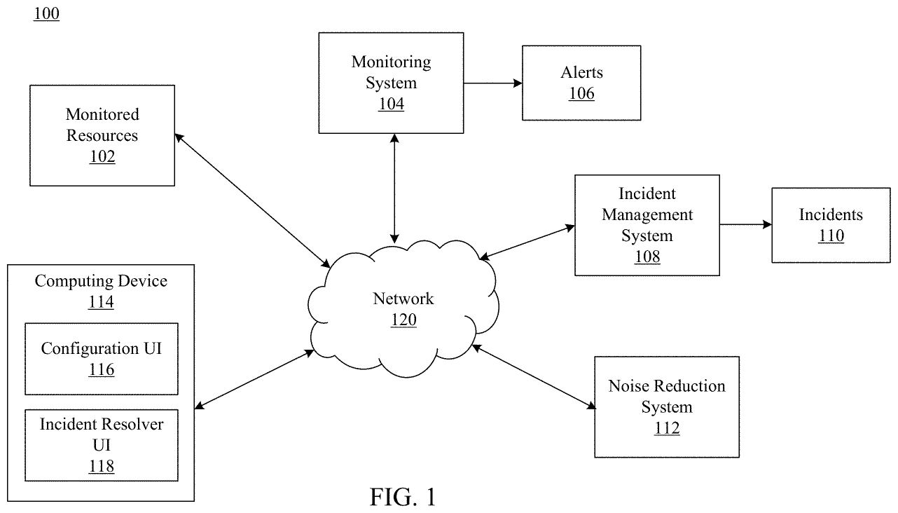

Example embodiments will now be described that are directed to techniques for identifying configuration parameters for issues generated in a computing environment. For instance, FIG. 1 shows a block diagram of a system 100 comprising a set of monitored resources 102, a monitoring system 104, an incident management system 108, a noise reduction system 112, and a computing device 114, each of which may be coupled via one or more networks 120. As illustrated in FIG. 1, monitoring system 104 may generate alerts 106, and incident management system 108 may generate incidents 110. Computing device 114 includes a configuration user interface (UI) and an incident resolver UI 118.

Network 120 may comprise one or more networks such as local area networks (LANs), wide area networks (WANs), enterprise networks, the Internet, etc., and may include one or more of wired and/or wireless portions. Monitored resources 102, monitoring system 104, incident management system 108, noise reduction system 112, and computing device 114 may communicate with each other via network 120 through a respective network interface. In an embodiment, monitored resources 102, monitoring system 104, incident management system 108, noise reduction system 112, and computing device 114 may communicate via one or more application programming interfaces (API). Each of these components will now be described in more detail.

Monitored resources 102 include any one or more resources that may be monitored for performance or any other health reasons. In examples, monitored resources 102 include applications or services that may be executing on a local computing device, on a server or collection of servers, on the cloud (e.g., as a web application or web-based service), or executing elsewhere. For instance, monitored resources 102 may include one or more nodes of a server, virtual machines, databases, software services, customer-impacting or customer-facing resources, or any other resource. As described in greater detail below, monitored resources 102 may be monitored for various performance or health parameters that may indicate whether the resources are performing as intended, or if issues may be present (e.g., excessive processor usage, excessive temperatures, etc.) that may potentially hinder performance of those resources.

Monitoring system 104 may include one or more devices (e.g., computing devices, servers, etc.) for monitoring the performance and/or health of monitored resources 102. For instance, monitoring system 104 may implement any number of monitors (e.g., algorithms or the like) for monitoring processor usage or load, processor temperatures, response times (e.g., network response times), memory usage, facility parameters (e.g., sensors present in a server room), or any other parameter that may be used to measure the performance or health of a resource. In examples, monitoring system 104 may continuously obtain from monitored resources 102 one or more real-time (or near real-time) signals for each of the monitored resources for measuring the resource's performance. In other examples, monitoring system 104 may obtain such signals at predetermined intervals or time(s) of day.

Monitors that are implemented in monitoring system 104 may generate alerts 106 based on signals received from monitored resources 102. In implementations, monitors may identify certain criteria that defines how or when an alert should be generated based on the received signals. For instance, a monitor may comprise a function that obtains the signals indicative of the performance or health of a resource, performance aggregation or other computations or mathematical operations on the signals (e.g., averaging), and compares the result with a predefined threshold. As an illustration, a monitor may be configured to determine whether a central processing unit (CPU) usage averaged over a certain time period exceeds a threshold usage value, and if the threshold is exceeded, an alert may be generated. This example is only illustrative, and monitors may be implemented to generate alerts for any performance or health parameter of monitored resources 102.

Incident management system 108 comprises any one or more devices (e.g., computing devices, servers, etc.) for managing the generation of incidents 110 occurring with respect to monitored resources 102. For instance, monitored resources 102 may include thousands of servers and thousands of user computers (e.g., desktops and laptops) connected to a network. The servers may each be a certain type of server such as a load balancing server, a firewall server, a database server, an authentication server, a personnel management server, a web server, a file system server, and so on. In addition, the user computers may each be a certain type such as a management computer, a technical support computer, a developer computer, a secretarial computer, and so on. Each server and user computer may have various applications and/or services installed that are needed to support the function of the computer. Monitoring system 104 may be configured to monitor the performance and/or health of each of such resources, and generate alerts where a monitor identifies potentially abnormal activity (e.g., predefined threshold values have been exceeded for a given monitor). Incident management system 108 may obtain those alerts and generate incidents 110 based on a potential issue with respect to monitored resources 102.

Incidents 110, for instance, may be any type of incident, including but not limited to, incidents generated as a result of monitoring monitored resources 102. In implementations, incidents may be generated based on alerts as described herein. In other implementations, incidents may also be generated manually by a user (e.g., a user of monitored resources 102). Incidents 110 may include reports that identify contextual information associated with an underlying issue with respect to one or more monitored resources 102. For instance, incidents 110 may include one or more downstream reports that identify alerts or events generated in the computing environment, where the alerts or events may indicate symptoms of a problem with any of monitored resources 102 upstream (e.g., an upstream service, application, etc.). As an illustrative example, an incident generated by incident management system 108 may include a report that any of monitored resources 102 is exceeding a threshold processor usage or a threshold temperature. In another example, an incident may also indicate (e.g., in the report) a temperature of a physical location of devices, such as a server room. As another illustrative example, an incident may include a report that a network ping exceeded a predetermined threshold. An incident may also include any type of report relating to a customer-impacting issue, where a customer relies on, operates, or otherwise utilizes any of monitored resources 102. However, these are examples only and are not intended to be limiting, and persons skilled in the relevant art(s) will appreciate that an incident as used herein may comprise any event occurring on or in relation to a computing device, system or network.

In some examples, incident management system 108 may generate an incident that may be regarded as noise. For instance, noise may include alerts that do not necessitate any changes be implemented in the computing environment to resolve the incident. An alert that may be regarded as noise may include, for example, an alert that a CPU has temporarily exceeded a threshold percentage of its processing usage. However, in such a scenario, a user may still need to acknowledge the incident or transfer the incident to another team, insert a date/time, mark the incident with a mitigated status, and resolve the incident. This example is only illustrative, however, and incident management system 108 may generate a variety of other types of incidents that may be regarded as noise, as well as incidents that may require actions to resolve the incident.

Incident management system 108 may implement a correlation engine for correlating together alerts that arise from the same underlying issue. In implementations, the correlation engine may apply a set of correlation rules that define how alerts should be correlated. For instance, different monitors may each generate alerts relating to a common underlying cause, resulting in separate alerts being provided to incident management system 108. In other examples, the same monitor may generate alerts for a monitored resource with a particular time window (e.g., a creation time window). In such instances, incident management system 108 may determine that the alerts should be grouped together into a single incident.

In example embodiments, incident management system 108 may correlate incoming alerts to incidents that have already been created. For instance, a correlation engine may determine, based on application of the set of correlation rules, whether a matching correlation rule is present. If a matching correlation rule is present, the correlation engine may determine if any active incident associated with the matching correlation rule exist. If an active incident exists, the alert may be correlated to the active incident. If no such active incident exists, or no matching correlation rule was found, incident management system 108 may create a new incident. It is understood that these examples are illustrative only, and that incident management system 108 may correlate incidents in any other manner as will be appreciated to those skilled in the relevant arts.

When an incident is created, incident management system 108 may provide the incident (e.g., as a report) to an engineer or team for resolution of the incident. The incident report may include contextual data associated with the incident, such as details relating to when the incident was generated, what monitors detected potentially abnormal activity, or any other data which may be useful in determining an appropriate action to resolve the incident. The incident report may be provided in any suitable manner, such as in incident resolver UI 118 that may be accessed by an engineer for viewing details relating to the incident as well as identifying actions to resolve the incident.

As will be described in greater detail below, noise reduction system 112 may identify and/or recommend configuration parameters for an alerting system described herein, such as monitoring system 104 or incident management system 108. Noise reduction system 112 may be implemented on one or more computing devices, servers, or on the cloud. In examples, noise reduction system 112 may be configured to analyze prior incident data that was generated using an existing set of configuration parameters, generate recommended configuration changes, and evaluate the recommended configuration changes to determine if a change in incident volume would result if the changes are implemented in the alerting system. In this manner, noise reduction system 112 may be configured to predict an overall incident volume reduction, thereby improving the quality of incidents 110 generated by incident management system 108.

For instance, noise reduction system 112 may be configured to optimize the configuration settings of monitoring system 104 by identifying higher or lower thresholds in one or more monitors. In another example, noise reduction system 112 may optimize configuration settings in incident management system 108 by revising, adding, or deleting one or more correlation rules that define how incidents are correlated. In some other examples, noise reduction system 112 may optimize configuration settings of both monitoring system 104 and incident management system 108. These examples are illustrative only, and further details regarding how configuration parameters may be identified will be described in greater detail below.

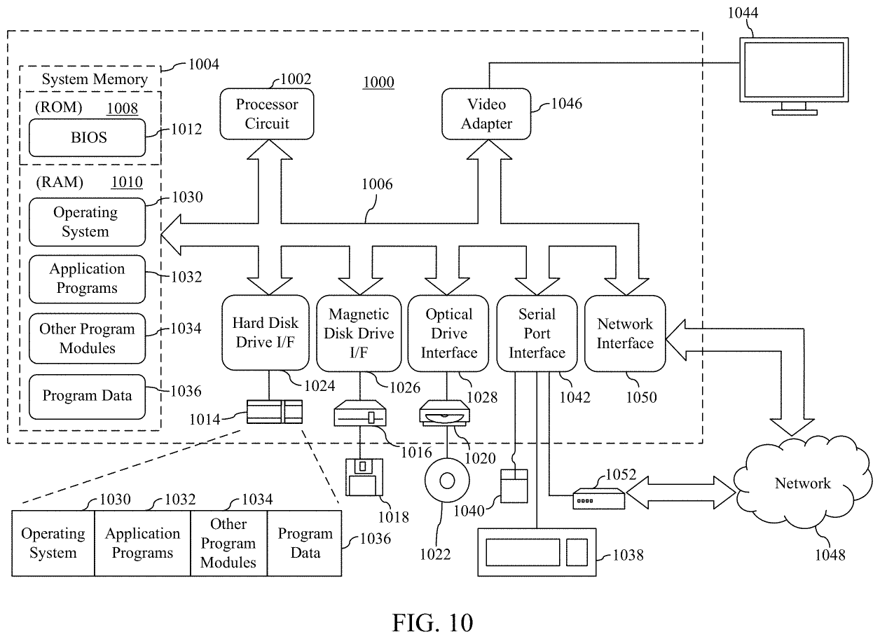

Computing device 114 may manage incidents generated with respect to network(s) 120 or monitored resources 102. Computing device 114 may represent a processor-based electronic device capable of executing computer programs installed thereon. In one embodiment, computing device 114 comprises a mobile device, such as a mobile phone (e.g., a smart phone), a laptop computer, a tablet computer, a netbook, a wearable computer, or any other mobile device capable of executing computing programs. In another embodiment, computing device 114 comprises a desktop computer, server, or other non-mobile computing platform that is capable of executing computing programs. An example computing device that may incorporate the functionality of computing device 114 will be discussed below in reference to FIG. 10. Although computing device 114 is shown as a standalone computing device, in an embodiment, computing device 114 may be included as a node(s) in one or more other computing devices (not shown), or as a virtual machine.

Configuration UI 116 may comprise an interface through which one or more configuration settings of monitoring system 104 and/or incident management system 108 may be inputted, reviewed, and/or accepted for implementation. For instance, configuration UI 116 may present a recommended configuration change identified by noise reduction system 112 for implementation on an alerting system for reducing a volume of incidents. In some implementations, configuration UI 116 may present one or more dashboards (e.g., reporting or analytics dashboards) or other interfaces for viewing performance and/or health information of monitored resources 102. In some further implementations, such dashboards or interfaces may also provide an insight associated with a change in incident volume if a recommended configuration change is implemented, such as an expected volume change (e.g., an estimated volume reduction expressed as a percent). These examples are not intended to be limiting, however, as configuration UI 116 may comprise any UI (such as an administrative console) or configuring aspects of monitoring system 104, incident management system 108, or any other system discussed herein.

Incident resolver UI 118 provides an interface for a user to view, manage, and/or respond to incidents 110. Incident resolver UI 118 may also be configured to provide any contextual data associated with each incident, such a time that the incident was generated, identification of the monitors that that led to generation of the incident, etc. In implementations, incident resolver UI 118 may present an interface through which a user can select any type of resolution action for an incident. Such resolution actions may be inputted manually, may be generated as recommended actions and provided on incident resolver UI 118 for selection, or identified in any other manner. In some implementations, incident resolver UI 118 generates notifications when a new incident arises, and may present such notification on a user interface or cause the notification to be transmitted (e.g., via e-mail, text message, or other messaging service) to an engineer or team responsible for addressing the incident.

It is noted and understood that implementations are not limited to the illustrative arrangement shown in FIG. 1. Rather, system 100 comprise any number of computing devices and/or servers coupled in any manner. For instance, though monitored resources 102, monitoring system 104, incident management system 108, noise reductions system 112, and computing device 114 are illustrated as separate from each other, any one or more of such components (or subcomponents) may be co-located, located remote from each other, may be implemented on a single computing device or server, or may be implemented on or distributed across one or more additional computing devices not expressly illustrated in FIG. 1.

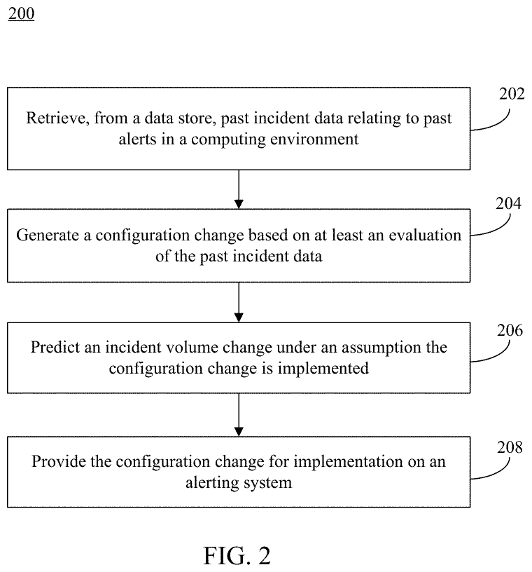

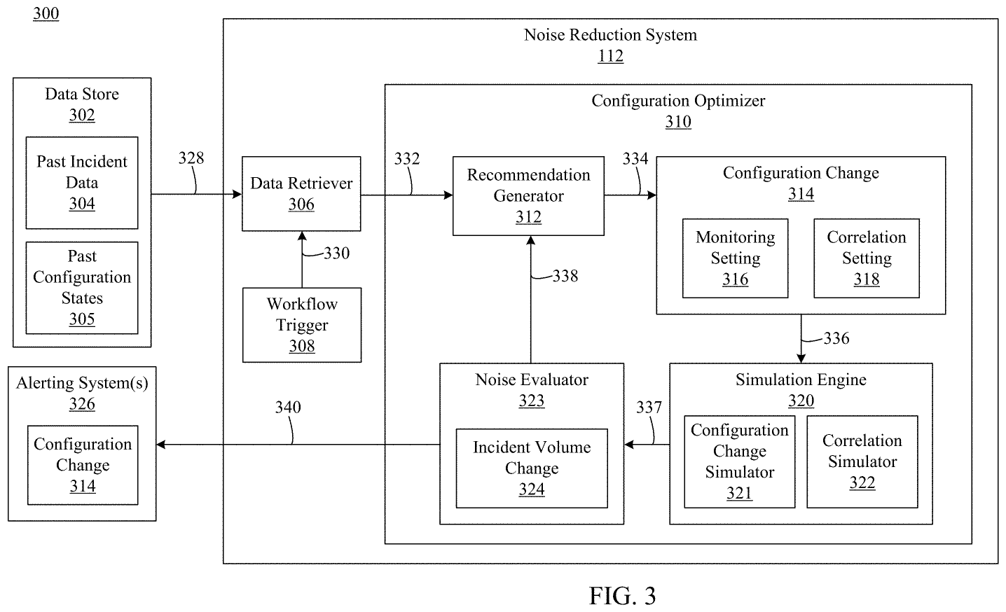

Noise reduction system 112 may operate in various ways to identify configuration parameters. For instance, noise reduction system 112 may operate according to FIG. 2. FIG. 2 shows a flowchart 200 of a method for identifying configuration parameters for generating issues in a computing environment, in accordance with an example embodiment. For illustrative purposes, flowchart 200 and noise reduction system 112 are described as follows with respect to FIG. 3.

FIG. 3 shows a block diagram of an example system for reducing incident noise in a computing environment, in accordance with an example embodiment. As shown in FIG. 3, system 300 includes a data store 302, an example implementation of noise reduction system 112, and one or more alerting systems 326. Data store 302 includes past incident data 304, which may comprise information relating to past alerts and/or incidents in the computing environment, and past configuration states 305, which comprise information relating to past configuration settings associated with past incident data 304 (e.g., the configuration settings of monitoring system 104 and/or incident management system 108 that were implemented when past alerts and/or incidents were generated in the computing environment). Noise reduction system includes a data retriever 306, workflow trigger 308, and a configuration optimizer 310. As shown in FIG. 3, configuration optimizer 310 includes a recommendation generator 312, a configuration change 314, a simulation engine 320, and a noise evaluator 323. Configuration change 314 can include a plurality of changes to configuration parameters of an alerting system, including but not limited to a monitoring setting 316 and a correlation setting 318. Simulation engine 320 comprises a configuration change simulator 321 and a correlation simulator 322. Noise evaluator 323 may determine an incident volume change 324. Noise evaluator 323 may provide configuration change 314 to one or more alerting system(s) 326 for implementation, as shown in FIG. 3.

Flowchart 200 begins with step 202. In step 202, past incident data relating to past alerts in a computing environment is retrieved from a data store. For instance, with reference to FIG. 3, data retriever 306 is configured to retrieve 328, from data store 302, past incident data 304. Data store 302 may comprise any suitable repository for storing historical information associated with the monitoring of monitored resources 102. Data store 302 may be storage device local to noise reduction system 112, a remotely located storage device, and/or comprise any other type of suitable storage (e.g., a cloud-based storage).

Past incident data 304 stored in data store 302 may comprise information relating to past alerts in a computing environment (e.g., alerts relating to any of monitored resources 102). For instance, past incident data 304 may include historical information relating to alerts 106 generated by monitoring system 104, or any other information logged by monitoring system 104 relating to performance and/or health metrics of monitored resources 102 (even if alerts 106 were not generated). Past incident data 304 may also include incidents 110 previously generated by incident management system 108, information relating to how each of incidents 110 were resolved (e.g., what actions were taken to resolve each incident), whether each incident was correlated with any other alerts, an identification of any correlated alerts for the incident, etc. Past incident data 304 may also include any additional information associated with each such alert or incident, such as a time when each alert or incident was generated, an identification of the monitors that led to triggering the alert or incident, an identification of any monitored values that led to triggering the alert or incident (e.g., the values that exceeded any predefined thresholds), and any other historical information associated with the alert or incident.

In some examples, data retriever 306 may also retrieve past configuration states 305 from data store 302. Past configuration states 305 may comprise the configuration state associated with each alert and/or incident identified in past incident data. For instance, past configuration states 305 may include configuration information associated with monitoring system 104 and/or incident management system 108 for past incident data 304, such as an identification of thresholds used for the monitors, information associated with correlation rules that were applied, or any other configuration state information that was implemented in the past when such past alerts and/or incidents were generated.

In some implementations, workflow trigger 308 may comprise a workflow to trigger 330 the retrieval of past incident data 304 by data retriever 306. For instance, workflow trigger 308 may cause data retriever 306 to retrieve past incident data 304 at predetermined intervals (e.g., hourly, daily, weekly, etc.), based on a schedule, and/or based on occurrence of another event. In some other implementations, data retriever 306 may retrieve past incident data 304 in response to a manual trigger, such as an administrator or engineer interacting with configuration UI 116 to trigger the retrieval. In this manner, noise reduction system 112 may be configured to continuously run to reduce incident noise over time.

In step 204, a configuration change based at least on an evaluation of the past incident data is generated. For instance, with reference to FIG. 3, recommendation generator 312 is configured to obtain 332 past incident data 304 and/or past configuration sates 305, and generate 334 configuration change 314 based at least on an evaluation thereof. Configuration change 314 can include any type of configuration change for one or more alerting system(s) 326, such as a monitoring setting 316 for monitoring system 104, a correlation setting 318 for incident management system 108, and/or any other configuration setting for any other alerting system not expressly shown in FIG. 1.

Recommendation generator 312 may generate configuration change 314 as a recommended configuration change in various ways. In implementations, recommendation generator 312 may analyze prior incident data 304 to identify configuration changes that are expected to make result in incident volume changes, if such changes are implemented on one or more alerting system(s) 326. For instance, recommendation generator 312 may implement any combination of data analytics, aggregation, statistics, or other algorithms to identify configuration settings that could potentially be changed to alter an overall incident volume. In example embodiments, recommendation generator 312 may generate configuration change 314 as a change in a setting that results in a reduction in an overall incident volume (e.g., a reduction in incidents 110). It is noted that recommendation generator 312 need not generate configuration change 314 as changes that result in a reduction in volume, but instead may also generate recommended changes that could be result in an increase in volume, or any other desired optimization on alerting system(s) 326.

As discussed earlier, configuration change 314 may comprise any type of configuration change for alerting system(s) 326, including but not limited to monitoring setting 316 for monitoring system 104, correlation setting 318 for incident management system 108, or any other configuration setting. In one example, recommendation generator 312 may identify a configuration setting with a missing value, and generate configuration change 314 as a replacement value for the configuration setting with the missing value. For instance, missing values in alerts generated by monitoring system 104 may be identified, such as values that may be used for correlation (e.g., important or critical values). Examples of such empty or missing values include, but are not limited to environment values or values that may be used to generate a correlation identifier (ID) which may be used by incident management system 108 to correlate different alerts into a single incident. When such values are missing in the alerts, correlation becomes more difficult, which can potentially lead to an increased number of incidents. By identifying such missing values and recommending replacement values (e.g., as recommended monitoring setting 316) to be used by monitoring system 104, the likelihood of correlation with other incidents will increase, leading to a reduction in a noise.

In another example, configuration change 314 may include a change in a spatial configuration setting. For instance, recommendation generator 312 may generate correlation setting 318 as a change in a spatial configuration setting that comprises a parameter that identifies the origin of an alert occurring in the computing environment. As an illustration, alerts occurring in a computing environment may have a correlation ID that identifies an underlying problem, symptom, or event related to the alert. The correlation ID, which may also be referred to as a correlation key, may be used to identify an origin of the alert. For example, if a particular underlying issue in a computing environment triggered multiple different alerts, each such alert may comprise the same correlation ID, since each alert originated from the same underlying issues. Where the correlation ID for different alerts is the same, incident management system 108 may correlate the alerts together, thereby avoiding the creation of multiple incidents for the same underlying issue.

In examples, the correlation ID for an alert may comprise a collection or concatenation of characteristics of the resource being monitored based on signals embedded in the monitoring. For instance, the correlation ID may comprise a predefined parameter (e.g., a string of characteristics) that includes a plurality of dimensions (e.g., a region, cluster, rack, node, etc.) used to identify an event occurring in the computing environment. In other words, the plurality of dimensions may comprise a set of characteristics that relate to how or where the alert originated in the computing environment. In some implementations, the correlation ID may comprise a plurality of dimensions in a hierarchical fashion (e.g., dimensions ranging from broad to granular characteristics associated with the monitored resource).

Where the correlation ID for two alerts is different, incident management system 108 typically precludes correlation of those two alerts. However, in some situations, the correlation ID of alerts may comprise dimensions that are unnecessary, which may result in the correlation ID of two alerts trigger from the same underlying issue having different values and therefore resulting in the inability to correlate the alerts together. Accordingly, correlation setting 318 may be configured to modify an existing correlation rule, or add a new one, to unify the diversity in correlation ID values in an effort to improve correlation and thereby reduce incident noise. Correlation setting 318 may, for instance, comprise a change in a spatial configuration setting that removes one or more dimensions in the correlation ID (e.g., by removing one of the bottom levels of the hierarchy), resulting in a broader correlation ID that can increase correlation of alerts. In some implementations, recommendation generator 312 may be configured to generate a plurality of recommended correlation setting changes alter a correlation ID in an incremental fashion (e.g., by reducing the hierarchy from the bottom to the top level-by-level), where a predicted noise reduction for each change may be evaluated separately until a desired noise reduction is achieved. It also noted that correlation setting 318 is not limited to a change in a spatial configuration setting that removes one or more dimensions as described herein, but may also include any other changes to one or more dimensions, such as a modification or addition of one or more dimensions.

In some other examples, configuration change 314 generated by recommendation generator 312 may comprise a change to a temporal configuration setting of a correlation rule. For instance, correlation rules utilized by incident management system 108 may be configured to correlate different alerts based on a temporal setting, such as a creation time. As an illustration, a correlation rule may define, as one factor in determining whether alerts can be correlated, a creation time window for which a new alert and an existing incident must belong in order for new alert to be added to the existing incident. In other words, an existing incident (e.g., an active incident that has not yet been resolved) may be a candidate for correlation only with an alert or alerts that was generated within a creation time window defined in the correlation rule. If the creation time window is too small, correlation may be precluded. Conversely, if the correlation time window is too large, alerts that are unrelated to an existing incident may be unintentionally correlated. In such scenarios, recommendation generator 312 may generate correlation setting 318 that comprises a change to such a temporal configuration setting of a correlation rule (e.g., to enlarge or decrease a creation time window), which may increase the likelihood of correlating incidents accurately and/or reduce an overall incident noise.

In another example, configuration change 314 generated by recommendation generator 312 may comprise a change to an automatic incident mitigator. For instance, in some implementations, monitoring system 104 and/or incident management system 108 may be configured to automatically mitigate an incident that was generated based on subsequent monitoring of the same resource. For example, if a monitored value for a particular resource exceeded a threshold value, resulting in the generation of an alert and creation of an incident, subsequent monitored values for the same resource may indicate that the values no longer exceed the threshold for a certain time period. In these instances, the incident may be regarded as a transient issue that has self-resolved (e.g., resolved without human intervention) and be automatically mitigated by monitoring system 104 and/or incident management system 108. In these examples, configuration change 314 may comprise a change to such an automatic incident mitigator, such as where the automatic incident mitigator may have been configured to prematurely mitigate the incident, or waited too long to automatically mitigate the incident.

In other examples, configuration change 314 generated by recommendation generator 312 may comprise a change to any other setting that defines whether an alert should be generated in monitoring system 104 for any given type of monitoring activity. For instance, configuration change 314 may comprise monitoring setting 316 that changes a threshold level used by a monitor in monitoring system 104 to determine whether or not an alert is to be generated (e.g., a threshold level of CPU usage). In another example, monitoring setting 316 may comprise a change to a number of occurrences of an exceeded threshold for a given resource that may need to be observed by monitoring system 104 prior to generating an alert (e.g., alerting a setting that indicates that an alert should be generated if CPU usage exceeds a threshold for a certain number of occurrences across a time window). In other examples, monitoring setting 316 may comprise a change to a time window used by monitoring system 104 in determining whether to generate an alert (e.g., monitoring CPU usage for 1-minute time windows). In yet other examples, monitoring setting 316 may comprise a change that defines any other parameter used by monitoring system (e.g., whether average CPU usage should be compared to a threshold, whether any CPU usage exceeding a threshold should potentially result in generation of an alert, etc.).

In implementations, numerical settings may be tuned arithmetically (e.g., +/−10), geometrically, or exponentially, and the resulting effect on noise may be calculated (as described in further detail below). In some further implementations, different numerical settings may be turned together, such as geometrically adjusting the creation time window for correlation while also linearly increasing (e.g., doubling) the automatic mitigation time for a monitor. In some further implementations, the numerical settings may be tuned in an incremental manner and the resulting on noise at each iteration may be determined.

In yet another example, correlation setting 318 may comprise a modification to any other correlation setting used by incident management system 108. For instance, correlation setting 318 may comprise a setting to create a new correlation rule, replace an existing correlation rule, update an existing correlation rule, or delete an existing correlation rule to reduce an incident noise to a desired level. It is noted and understood that the examples described herein are illustrative only, and other types of configuration changes may be generated as will be appreciated by those skilled in the relevant arts to reduce or change an incident noise level.

In some other examples, recommendation generator 312 may also be configured to generate configuration change 314 using past configuration states 305. For instance, recommendation generator 305 may generate one or more recommended configuration changes based on how effective prior configuration settings were (e.g., manually implemented by a user and/or recommended by configuration optimizer 304) in achieving a desired incident volume, and whether any additional configuration changes should be evaluated for achieving the desired incident volume (e.g., based on whether configuration changes may be implemented that reduces an incident volume in a manner that does not miss important or critical incidents).

Referring back to FIG. 2, in step 206, an incident volume change is predicted under an assumption the configuration change is implemented. For instance, with reference to FIG. 3, configuration change simulator 321 of simulation engine 320 may obtain 336 configuration change 314 and simulate an implementation of configuration change 314. Correlation simulator 322 may be configured to simulate a correlation of alerts after configuration change 314 is simulated. Noise evaluator 323 may obtain 337 the simulated correlation and predict incident volume change 324 under an assumption the configuration change is implemented. Additional details regarding the operation of simulation engine 320 and noise evaluator 323 will be described below.

Noise evaluator 323 may predict incident volume change 324 by identifying a number of incidents in past incident data 304 (e.g., a total number of incidents for a time window to which the past incident data pertains) with a number of incidents that would be expected based on a simulation that implements configuration change 314. For example, noise evaluator 323 may compare a total number of historical incidents to a total number of incidents that would have resulted if the recommended change was based on the same set of monitoring data. In this manner, noise evaluator 323 may determine whether implementation of configuration change 314 would have resulted in a decrease in incidents, an increase in incidents, or no change in the overall number of incidents occurring in the computing environment.

In some further implementations, noise evaluator 323 may be configured to cause 338 recommendation generator 312 to generate one or more additional recommended configuration changes based on incident volume change 324. For instance, if desired reduction in incidents was not predicted (e.g., incident volume change 324 did not exceed a threshold amount of change) on an assumption that configuration change 314 was implemented, noise evaluator 323 may cause recommendation generator 312 to generate additional recommended changes, such as other changes that are expected to result in a reduction of incidents (or a greater reduction). In some further implementations, configuration optimizer 310 may repeat such a process in an iterative fashion until a desired incident volume change (e.g., a desired reduction in incidents) is achieved, and/or until a predetermined number of iterations have been performed. It is also noted and understood that noise evaluator 323 is not limited to predicting incident volume change 324 for a single recommended configuration change, but may also be configured to predict an overall or total incident volume change under an assumption that a plurality of recommended configuration changes are implemented together (e.g., based on simulation engine 320 simulating one or more monitoring settings and/or correlation settings 318 in the same simulation).

In step 208, the configuration change is provided for implementation on an alerting system. For instance, with reference to FIG. 3, noise evaluator 323 is configured to provide 340 correlation change 314 for implementation on one or more alerting system(s) 326. For example, noise evaluator 323 may provide monitoring setting 316 for implementation on monitoring system 104, correlation setting 318 for implementation on incident management system 108, or both.

Noise evaluator 323 may be configured to provide correlation change 314 for implementation on alerting system(s) 326 in a number of ways. For example, noise evaluator 323 may provide the configuration change for implementation if a determination is made that incident volume change 324 achieved a desired goal, such as a predicted reduction in a volume of incidents that exceeded a threshold amount (or an increase in incidents that exceeded a threshold amount). Accordingly, in some implementations, noise evaluator 323 may not provide configuration change 314 for implementation on alerting system(s) 326 where a simulated implementation of the change did not result in a desired volume change, such as where only a trivial volume change is preserved.

In some implementations, noise evaluator 323 may provide configuration change 314 and/or incident volume change 324 associated therewith to a data warehouse or other data repository where configuration change 314 and/or incident volume change 324 may be accessed by one or more users via a suitable interface. For example, configuration change 314 and/or incident volume change 324 may be accessed via configuration UI 116 where a user may view the recommended configuration change, as well as a data insight that identifies the predicted noise reduction if the change is implemented. In some implementations, noise evaluator 323 may provide configuration change 314 as a recommended change for implementation on alerting system(s) 326 that a user may review and/or accept via configuration UI 116. In yet other implementations, noise evaluator 323 may provide configuration change 314 to alerting system(s) 326 such that the configuration change is automatically implemented (e.g., without user intervention). Such automatic implementation may occur, for instance, where a measure of confidence that the change should be implemented exceeds a threshold. In such examples, noise evaluator 323 may also be configured to provide a notification to a user, such as via configuration UI 116, that configuration change 314 was automatically implemented on alerting system(s) 326.

In this manner, configuration optimizer 310 may automatically generate recommended configuration changes for potential implementation on an alerting system, simulate the changes using past incident data, and evaluate whether the changes resulted in a desired incident volume change prior to recommending the changes to a user. As an illustration, if a threshold for a particular monitor in monitoring system 104 was set too low, resulting in many false positive alerts, configuration optimizer 310 may automatically identify and test different thresholds for the monitor that would result in a decreased incident volume to reduce the number of false positive alerts, thereby improving the efficacy of monitoring system 104 and/or incident management system 108.

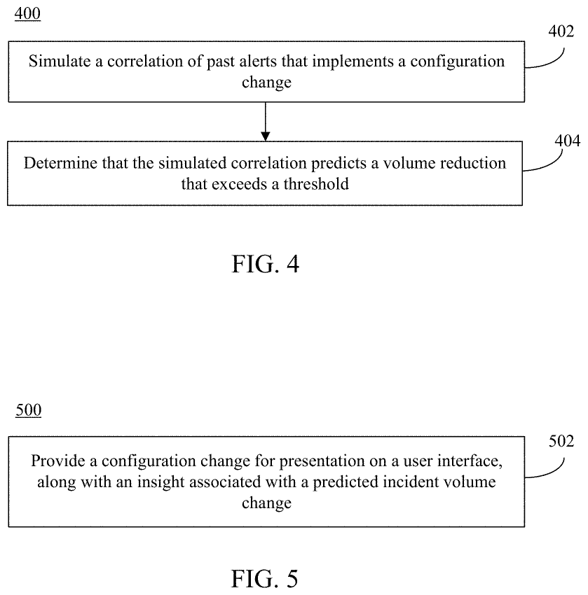

As described above, noise evaluator 323 can predict incident volume change 324 in various ways. For example, FIG. 4 shows a flowchart of a method for predicting an incident volume change by simulating a correlation of past alerts, in accordance with an example embodiment. In an implementation, the method of flowchart 400 may be implemented by simulation engine 320 and noise evaluator 323. FIG. 4 is described with continued reference to FIG. 3. Other structural and operational implementations will be apparent to persons skilled in the relevant art(s) based on the following discussion regarding flowchart 400 and system 300 of FIG. 3.

Flowchart 400 begins with step 402. In step 402, a correlation of past alerts is simulated that implements a configuration change. For instance, with reference to FIG. 3, simulation engine 320 may be configured to simulate a correlation of alerts in past incident data 304, where the simulation implements configuration change 314 determined by recommendation generator 312. For example, configuration change simulator 321 may simulate an implementation of configuration change 314. Configuration change simulator 321 may simulate the implementation of the configuration change in various ways. In some example embodiments, configuration change simulator 321 may simulate implementation of the configuration change using past incident data 304. For instance, configuration change simulator 321 may simulate implementation of a recommended monitoring change in a simulated environment (e.g., by replacing a missing value identified in an alert with a replacement value as described earlier) using past incident data 304, and generate a set of simulated alerts.

In implementations, correlation simulator 322 may simulate a correlation of alerts after configuration change simulator 321 simulates implementation of one or more changes described herein. Correlation simulator 322 may be configured to implement, in a simulated setting, one or more other recommended configuration changes, such as correlation setting 318. For instance, correlation simulator 322 may simulate a correlation of alerts that were generated by configuration change simulator 321. In this manner, simulation engine 320 may be configured to simulate a generation of incidents under an assumption configuration change 314 is implemented in the computing environment. In other words, configuration change simulator 321 and/or correlation simulator 322 may simulate implementation of configuration change 314 in one or more simulated systems of the computing environment (e.g., monitoring system 104, incident management system 108, etc.) using past incident data 304 to generate a simulated set of incidents under an assumption the change was implemented.

As an illustration, configuration change 314 may comprise a recommended change to a threshold setting of a monitor implemented in monitoring system 104. In this illustration, configuration change simulator 321 may implement the recommended change to the threshold setting in a simulated environment using past incident data 304, and correlation simulator 322 may simulate a correlation of alerts in the simulated environment where the change is implemented. In such examples, noise evaluator 323 may predict incident volume change 324 under the assumption the configuration change is implemented. Thus, based on past incident data 304 and the change to the threshold setting, noise evaluator 323 may determine that the number of alerts generated for the particular monitor using the changed threshold setting has been reduced (as simulated by simulation engine 320), which may also lead to a reduction in the overall number of incidents generated by incident management system 108.

In another illustration, configuration change 314 may comprise a change to a correlation rule implemented in incident management system 108, such as increasing a creation time window for a correlation rule. In such an illustration, correlation simulator 322 may be configured analyze alerts associated with past incident data 304 (which may be historical alerts that occurred in the computing environment, or simulated alerts if configuration change simulator 321 has simulated other changes, such as monitoring changes) with the revised creation time window in a simulated setting to generate a simulated set of incidents. It is noted that these illustrations are not intended to be limiting, and that correlation simulator 322 may be configured to simulate a correlation of past alerts in a simulation that implements any configuration change, or combination of configuration changes, that may potentially result in a change to an incident volume.

In step 404, it is determined that the simulated correlation predicts a volume reduction that exceeds a threshold. For instance, with reference to FIG. 3, noise evaluator 323 may determine that the simulated correlation predicts an incident volume reduction that exceeds a threshold. As an example, simulation engine 320 may simulate a correlation of past alerts in a simulated setting that implements configuration change 314, and noise evaluator 323 may determine incident volume change 324 by comparing a number of incidents generated in the simulated correlation with a number of actual incidents generated for the same past incident data 304. In such an example, noise evaluator 323 may determine that incident volume change 324 comprised a reduction of incidents (e.g., an 80% reduction in incident volume is predicted if a recommended change is implemented) that exceeded a threshold amount (e.g., a 50% reduction threshold). As described earlier, if it is determined that such a reduction exceeds a threshold amount, noise evaluator 323 may provide the recommended configuration change for implementation on alerting system(s) 326 such that the change may be made (e.g., automatically or in response to a user interaction) to reduce the number of incidents in the computing environment.

As described above, configuration change 314 may be provided for implementation on an alerting system in various ways. For example, FIG. 5 shows a flowchart of a method for providing an insight associated with a predicted incident volume change, in accordance with an example embodiment. In an implementation, the method of flowchart 500 may be implemented by configuration UI 116, configuration optimizer 310, and/or alerting system(s) 326. FIG. 5 is described with continued reference to FIGS. 1 and 3. Other structural and operational implementations will be apparent to persons skilled in the relevant art(s) based on the following discussion regarding flowchart 500, system 100 of FIG. 1, and system 300 of FIG. 3.

Flowchart 500 begins with step 502. In step 502, the configuration change is provided for presentation on a user interface, along with an insight associated with the predicted incident volume change. For instance, with reference to FIGS. 1 and 3, noise evaluator 323 may be configured to provided configuration change 314, as well as an insight associated with incident volume change 324, for presentation on a user interface, such as configuration UI 116. The insight associated with incident volume change 324 may comprise an indication identifying or describing a predicted volume change if configuration change 314 is implemented on alerting system(s) 326, such as a simplified data-driven explanation that describes the basis for providing the recommendation. In some examples, the insight may comprise an estimated percentage reduction (or increase) of incidents, a number of reduced (or increased) incidents, an estimated reduction (or increase) in engineer workloads if the change is implemented on alerting system(s) 326. In another example, the insight may comprise an indication that 90% of similar alerts (e.g., based on matching a title or source metadata of the alerts) would be linked or correlated if the recommended change is implemented in alerting system(s) 326, thereby resulting in a reduction in generated incidents. These examples are not intended to be limiting, however, and it will be appreciated that an insight as used herein accompanying configuration change 314 may comprise any simplified data-driven explanation or evidence that may describe the basis for providing the recommended configuration change.

It is noted that the above systems and methods are not intended to be limiting. Persons skilled in the relevant art(s) will understand that the all of the techniques described herein may be extended to any issues (e.g., IT issues) in a computing environment. Furthermore, because the techniques may be extended to any IT tasks, persons skilled in the relevant art(s) will understand that the reports described herein can relate to any event occurring in a computing environment.

### III. Additional Automatic Incident Noise Tuning Embodiments

A. Introduction

The following sections are intended to describe additional example embodiments in which implementations described herein may be provided. Furthermore, the sections that follow explain additional context for such example embodiments, details relating to the implementations, and evaluations of such implementations. The sections that follow are intended to illustrate various aspects and/or benefits that may be achieved based on techniques described herein, and are not intended to be limiting. Accordingly, while additional example embodiments are described, it is understood that the features and evaluation results described below are not required in all implementations.

In example automatic incident noise tuning embodiments, techniques may be implemented by one or more of monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, and/or alerting system 326 (including any subcomponents thereof). Other structural and operational implementations will be apparent to persons skilled in the relevant art(s) based on the following discussion.

The increasing demands for always-on and fast-response online services have driven cloud data centers to undergo tremendous growth. To get a unified view of operational health, operators may collect detailed monitoring data across resources, applications, and services (e.g., monitored resources 102). A challenge that influences service availability is how to identify actionable alerts from monitoring data. To ensure a high signal to noise ratio, it may be important for service operators to perform quantitative analysis of (a) the configurations of the monitors to reduce noisy alerts at the source and (b) the rules to correlate alerts in incident management systems. Accordingly, operators should have the ability to propose hypothetical configuration settings and quantitatively analyze their impact on the performance of the monitoring system. Such impact analysis may comprise analyzing alert and incident workloads over the monitors, estimating changes to alert settings (e.g., alerting threshold, auto mitigation time window), and studying adoption of recommended changes while taking into account the projected changes in the alert volumes. The design, implementation, and experiences building noise reduction system 112, a scalable analyzer for cloud services as well as other computing environments, are discussed herein. Further, algorithms and interfaces exposed by noise reduction system 112 are also discussed herein. Further, implementation techniques for efficiently supporting noise reduction system 112 is also discussed herein. Noise reduction system 112 can also be extended to incorporate similar analysis of other aspects of end-to-end monitoring systems.

In a cloud setting and other computing environments, there are typically two platforms that handle alerts: (1) monitoring systems that track service metrics (e.g., CPU, latency, etc.) and provide functionality to generate alerts, and (2) incident management systems that receive these alerts and link them together via operator-specified rules into a single incident. Monitoring systems are often stateless and keep creating alerts until the issue is resolved. The incident management system may maintain the state of the incident and has a correlation engine that suppresses alerts, correlates multiple alerts or creates new incidents using operator-defined correlation rules. To ensure both systems work in synergy, engineers and operators typically ensure that monitoring thresholds and configuration settings in the monitors and correlation rules are properly configured. If such proper configuration is not employed (e.g., due to human error or otherwise), a risk of a spike in duplicate incidents may result. As monitors and rules are typically configured conservatively (e.g., generate an alert even though the issue might be transient or did not cause any customer impact), it risks many false positive incidents, thereby increasing the incident noise and incident volume. Further, this results in alert fatigue false phone calls and e-mail notifications to the on-call engineer and repeated or excessive notifications while the engineer is already working on handling incident-related tasks. As the number of services in computing environments is constantly increasing, it is important to address the incident volume increases to improve productivity and efficiency of on-call engineers.

However, addressing incident volume increases at a cloud scale may have certain challenges. For instance, heterogeneity in monitor configuration settings may make it difficult to analyze the incidents and generalize the recommendation actions. In clouds, there can be several hundred thousand monitors with each monitor having many custom dimensions and the set of distinct values for each dimension can be up to hundreds or thousands. Further, in production systems, changing settings on-line to measure its impact poses a risk as it might lead to loss of incidents or a flood of false incidents. Further, to evaluate different correlation settings, each incident has to be potentially correlated with every incident prior in time which incurs O(n²) time complexity, which poses a scalability challenge to handle tens to hundreds of thousands of alerts. Still further, to achieve benefits from the recommended configuration settings, changes may need to be performed across each of underlying systems such as monitors, incident management, and automation workflows that execute actions on these incidents, which can be in the order of tens of thousands.

1. Contributions

In some implementations, noise reduction system 112 is a scalable analyzer that aggregates and analyzes past incidents (e.g., millions of incidents), generates recommendations to update the monitor and incident management configuration settings, and calculates the estimated volume reduction for each suggested change as well as cumulative improvement across all changes. Noise reduction system 112 may run any suitable framework, including but not limited to a MapReduce based computational pipeline. Noise reduction system 112 may run periodically, e.g., daily and employ an algorithm to scale the correlation simulation and estimate the volume reduction for millions of incidents for each recommended action. These actions may comprise three categories, though these categories are not intended to be limiting: (i) identifying missing configuration settings to reduce or eliminate duplicate incidents, (ii) generating optimal spatial configuration settings to correlate the incidents having the same underlying issue, and (3) generating optimal temporal configuration settings to reduce or eliminate duplicate incidents.

Further, a scalable end-to-end architecture is discussed herein to tackle this problem for large incident volumes. A comprehensive evaluation showing the estimated savings per action type and production case studies on how noise reduction system 112 helped reduce the noise for cloud services is described below.

B. Environment

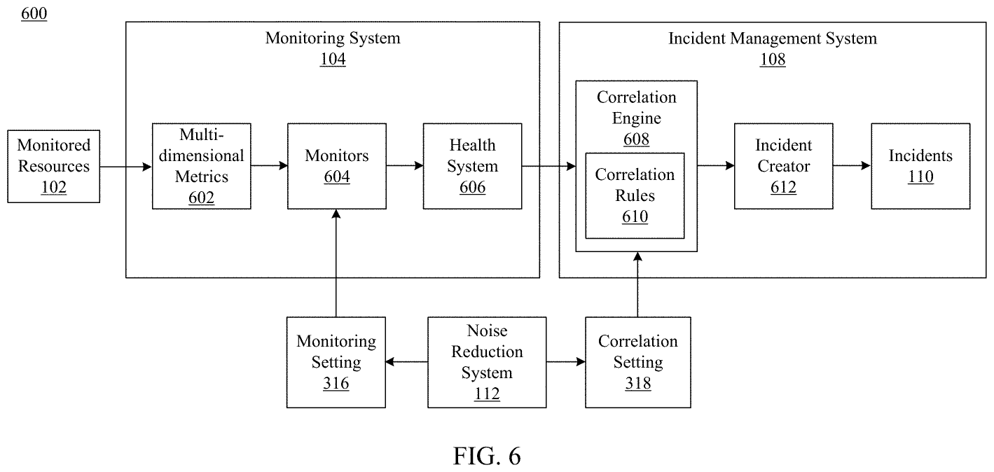

FIG. 6 shows a block diagram of an illustrative system that may implement configuration changes, in accordance with an example embodiment. System 600 includes an example implementation of monitored resources 102, monitoring system 104, incident management system 108, noise reduction system 112, monitoring setting 316, and correlation setting 318. As shown in FIG. 6, monitoring system 104 comprises multi-dimensional metrics 602 that are obtained from monitored resources, monitors 604, and a health system 606. Incident management system 108 includes a correlation engine 608, an incident creator 612, and incidents 110. Correlation engine 608 may include one or more correlation rules 610. As illustrated in FIG. 6, monitoring setting 316 that has been generated and/or evaluated in noise reduction system 112 may be provided as changes for implementation in monitors 604. Similarly, correlation setting 318 may be provided as changes for implementation in correlation engine 608, such as a change to one or more correlation rules 610. Components of system 600 will be described in further detail as follows.

Monitoring system 104 may collect multi-dimensional metrics 602, e.g., latency, number of connections, CPU, etc. generated by applications and services, and track these metrics to evaluate the performance and health of services. When service performance degrades, alerts can get raised with meta-tags and sent to the incident management system. Typically, the monitoring systems are stateless. For instance, during a service issue, monitors may constantly send alerts to the incident management system at a specified frequency until the issue is resolved. The incident management system may handle alerts from different monitoring systems and automation workflows, correlate alerts to create incidents and notify the on-call engineer(s). Specifically, when a new alert arrives, the incident management system may track all active incidents (which have not been mitigated) and run an engine that applies correlation rules to match the alert against them. If a match is found, the alert is either discarded or linked as a child incident to the matched active incident (thereafter becomes a parent incident). This process, referred to as correlation, reduces and/or prevents noisy or duplicate alerts from inflating incident volumes.

1. Monitors

A metric (e.g., one of multi-dimensional metrics 602) is a measurement of an event that has occurred. For instance, a metric may include, but is not limited to, a latency, failure count, CPU information, etc. Monitoring systems typically collect application and system counters with multiple dimensions in near real-time. Monitors 604 may be created from these metrics to measure the performance of a service. While creating a monitor, an alerting logic is specified to monitor the performance of the metric and generate an alert. For example, monitor 602 may be created to measure the availability of a service with multiple instances which are deployed on multiple servers across datacenters. A metric may be generated from each of the application instances with the instance name, server name, datacenter and region as the metric dimensions. In some implementations, the correlation ID and the instance spatial fields contains all these above dimension values. A single monitor may be created which measures the availability for all the instances. When the availability drops for a particular instance, health system 606 may raise an alert for it.

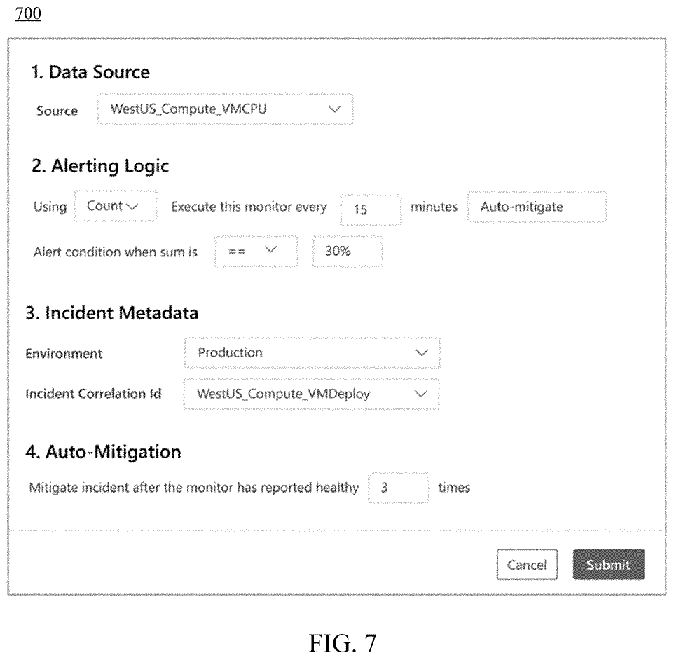

For instance, FIG. 7 shows an illustrative user interface 700 depicting a set of configuration parameters in a monitoring system, in accordance with an example embodiment. In this illustrative interface, various configuration parameters may be provided for one of monitors 604 implemented in monitoring system 104. As shown in FIG. 7, a data source for the monitored resource, alerting logic identifying parameters related to how alerts should be generated for the monitored resource (e.g., how often the alerting logic executes, auto-mitigation parameters, threshold parameters, etc.), incident metadata identifying an environment and correlation ID, an auto-mitigation configuration parameters. In accordance with techniques described herein, changes any one or more of these illustrative configuration parameters may be recommended and/or evaluated to automatically tune incident noise. It is noted and appreciated that the interface and parameters shown in FIG. 7 is meant to be illustrative only, and any other suitable configuration parameters for monitors 604 may be implemented.

2. Correlation Rules

Correlation engine 608 typically comprise rule-based systems where engineers add rules to suppress (correlate) the duplicate (related) alerts. For a given alert, a set of correlation rules 610 that match the alert may be filtered and the highest priority rule selected. Based on the matching criteria in the rule, a matching active parent incident may be selected.

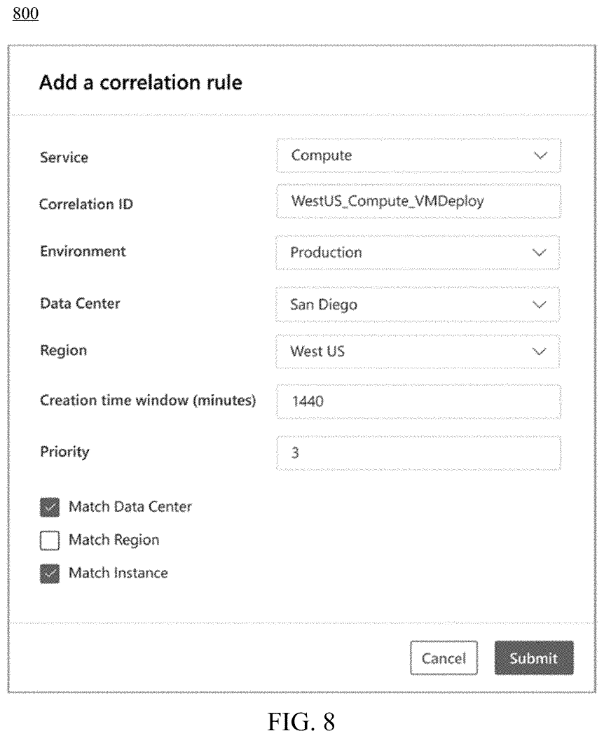

For instance, FIG. 8 shows an illustrative user interface 800 depicting a set of configuration parameters in an incident management system, in accordance with an example embodiment. As shown in FIG. 8, user interface 800 may identify various configuration settings for a correlation rule that is used to correlate an incoming alert to an incident that has previously been created. For instance, correlation rule settings may include, but are not limited to, parameters related to a service, correlation ID, environment, data center, region, creation time window, priority, and one or more matching rules. These settings are illustrative only, and other settings used to correlate alerts and incidents are also contemplated. A brief description example configuration settings is described below.

Correlation ID: The correlation ID in alerts and incidents typically utilize this field to perform correlation. In a correlation rule, this field may contain a value or be empty. In some implementations, a correlation ID in correlation rule may match with all correlation IDs. Typically, the correlation ID in an incident contains the monitor information and its dimensions which uniquely identify the event, although the correlation ID may contain other information as well.

Environment: Incidents and correlation rules typically have an environment value set to correlate the incidents.

Spatial fields: Spatial fields in a correlation rule or an incident may either be empty or can contain a value. An empty spatial field in correlation rule may any field value in some implementations. Some of the supported spatial fields are cloud instance (e.g., public cloud, private cloud), data center, and geographic region.

Creation time window: This field is typically used in correlation rules. In some implementations, correlation engines may determine an active incident as a candidate for correlation with those alerts that were created within the creation time window.

Priority: Services typically specify multiple correlation rules with different priorities. High priority rules precede the lower priority rules when finding the matching correlation rule.

Match spatial fields: These Boolean fields may be used to determine the matching criteria for selecting an active incident for correlation. The selected spatial fields are typically not empty and match the current alert and the active parent incident. In example embodiments, some of the supported fields are match instance, match data center, and match region.

The process of correlating alerts with incidents may have two stages in example implementations. These stages are described below.

1. Find a correlation rule: When an alert arrives, the correlation engine filter correlation rules 610 based on the correlation ID, environment, and spatial fields. If there are multiple rules, the one with the highest priority may take precedence. If no matching correlation rule is found, incident creator 612 may create a new incident for the alert.

2. Find a matching active parent incident: For a given alert and matching correlation rule, the correlation engine may look for all active parent incidents whose creation time are within the creation time window for the alert. Next, the earliest active parent incident may be selected that matches on the selected spatial fields in which case the alert may be suppressed or correlated. Otherwise, incident creator 612 may create a new incident.

C. Overview

In examples, noise reduction system 112 may past alert and incident data and recommends actions to reduce incident volume noise based on the three recommendation engines described below. Noise reduction system 112 may load the past incident data, extract the relevant information, and aggregate it. The data may first pass through recommendation engines in which statistical inference is used to generate potential recommended actions. The data may then be transformed by automatically applying these actions. The correlation simulation engine, which may emulate a production alert correlation engine, is executed and an incident volume reduction may be obtained. Finally, a recommendation may be suggested if there is a potential reduction. Details of the approach and the end-to-end model architecture are described as follows to reduce the incident volume.

1. Approach

Before analyzing the incidents, the correlation engine may be first executed to find the matching correlation rule for each incident. This step assumes that the correlation occurs within the monitor-generated incidents; other types include incidents reported directly by customers. Since the configuration setting changes should be made in the monitors or correlation rules, the incidents are aggregated based on the monitor ID and the recommendations are generated at the monitor level. Noise reduction system 112 may comprise of four approaches in some implementations:

Identify the missing configuration settings: When the required fields for correlation (e.g., correlation ID, environment, matching spatial fields) are missing in the incidents, correlation may fail which results in a high volume of duplicate incidents. In this recommendation type, incidents with missing environment, correlation ID, and other spatial fields that are specified in the matching correlation rule may be identified. These empty fields are filled with the most granular information available in the incident. Empty environment is substituted with a constant value, empty correlation ID with a constant value, and the empty spatial fields with the concatenation of environment and correlation ID. It is noted that these values are placeholder settings to differentiate from empty values and operators can replace them with their custom values when taking this action. The volume reduction may be estimated by rerunning the correlation simulation engine on the modified incident data.

Add a default, catch-all correlation rule: Given that the monitors are usually stateless, the state of the alerts is typically maintained in the incident management system. The correlation engine may correlate all ongoing alerts to the current incident and prevent duplication. A default correlation rule for each service may match the incidents for that service. When this rule is missing, incidents which do not match any other correlation rule may generate duplicate incidents depending upon the monitor alert frequency. Such cases are identified, and a default correlation rule is added to the system. The correlation simulation engine may be rerun to showcase the estimated volume reduction due to the recommended actions.

Update the spatial configuration settings: When monitor dimensions are too granular, with each dimension taking many values, all possible different combinations can potentially generate a large incident volume. For example, consider a monitor measuring the performance of a service that has virtual machine name, data center, and region as dimensions and is deployed in many regions. If this monitor creates a burst of incidents and corresponding phone calls and e-mail notifications for many virtual machines in a short span of time, it may not be feasible for an on-call engineer to analyze all the incidents. Such a scenario is usually due to a common underlying issue that the on-call engineer is already attending to. If this pattern happens multiple times, it may be determined that there is no need to have the virtual machine as a part of the correlation ID and the corresponding matching spatial field. By removing the fine-grained dimensions, the incident volume and the noisy alert notifications may be reduced.

For a monitor, noise reductions system 112 may consider the data for about D days and partitions it into h-hour bins, where h is a small window such as 1 hour. It then calculates the total number of bins (denoted as #bins) which contain the incidents and the number of bins which contain at least a threshold of distinct correlation IDs (denoted as #filteredBins). In some implementations, noise reductions system 112 may consider a monitor if #bins is above a threshold and #filteredBins is above a fraction of #bins. This helps eliminate monitors which do not have many incidents over D days and monitors which do have many incidents but only generated a few incidents over a short span of time. This can also be viewed as selecting the monitors which generate a high spike of incidents multiple times in D days. For each incident, the dimensions from correlation ID may be identified by splitting at pre-specified delimiters such as ‘:’ or ‘_’. For each bin b and dimension d, the number of distinct dimension values #distinctValues_{b,d} may be calculated and the total number of incidents in each bin #incidents_{b} may be calculated. The dimension score may be computed as

$$\frac{\# {distinctValues}_{b , d}}{\# {incidents}_{b + 1}} .$$

Plus 1 in the denominator is Laplacian correction to further smooth the dimension score when the number of incidents is relatively small. The dimensions to remove may be selected if the average dimension score of all the bins is greater than the threshold.

Noise reduction system may rerun the correlation engine after removing the dimensions from the correlation ID and corresponding matching spatial fields to estimate the volume reduction and recommend this action.

Update the temporal configuration settings: Two illustrative temporal configuration settings are described below: creation time window in the correlation rules and the auto-mitigation time in monitors.

A creation window setting allows two active incidents created within the specified time interval to correlate. Often, even though an active incident may exist for correlation, if the creation window is too small, the new incident cannot find an active parent incident in the small time window, which may result in creation of a duplicate incident. Conversely, having a large creation window might result in correlating incidents due to different root causes and also might cause parent incidents to be long-running, as new alerts keep getting correlated against them. Noise reduction system 112 may recommend a new creation window based on the past incident creation patterns. In implementations, noise reduction system 112 may partition the incidents such that all the incidents which have an overlapping active interval time are together and the time difference between the earliest and the latest incidents is less than a threshold. The estimated creation time window may be calculated for each partition as the creation time difference between the earliest and the latest incident. In a non-limiting illustration, noise reduction system 112 may recommend the new creation time window as the 90th percentile of the estimated creation time windows calculated from each partition. Using these new creation time windows, noise reduction system 112 may simulate the correlation engine and recommend the action if there is a potential volume reduction.

In example embodiments, monitoring systems may have an auto-mitigation time T setting. After raising an alert, the monitor may continuously evaluate if the monitor remains healthy for the last T number of times and if so, the monitor may mitigate the incident. If the monitor signal shows temporary recovery to healthy state or the auto-mitigation time is too small, the incident may be falsely mitigated. Since the incident is mitigated and the monitor still observes the performance degradation, a new incident may result. This may be referred to as a “Create-Mitigate-Create” cycle. Noise reduction system 112 may analyze the past incidents and find these Create-Mitigate-Create cycles. Noise reduction system 112 may recommend the auto-mitigation time to reduce the incident volume by keeping the incident open for a relatively longer time.

As an illustration, an auto-mitigation component of a monitor in monitoring system 104 (e.g., as shown in FIG. 7) may be configured to automatically mitigate an incident if the monitor determines that the resource is functioning properly (e.g., performing healthy and/or in accordance with desired performance parameters) for a specified time period, Y. Such auto-mitigation components may also be configured to avoid handling transient issues and/or perform a validation if the monitored resource has recovered. In examples, the time period Y may be set by identifying an optimal auto-mitigation time. For instance, a small auto-mitigation may result in unnecessary duplicate incidents, while a large auto-mitigation time may result in a larger time to mitigation (TTM) and/or merging of unrelated issues. Accordingly, to reduce duplicate incidents in the computing environment, an auto-mitigation time may be identified by increasing the auto-mitigation time based on a time difference between an incident that was automatically mitigated and the next active incident. In such examples, statistical thresholding may also be employed to avoid or reduce a large TTM and/or merging of unrelated issues. A recommended change to an auto-mitigation time in implementations may be based on a percentile of observed increases to auto-mitigation times for a monitor (e.g., selecting an auto-mitigation time for a monitor that is at the 90th percentile of the observed increases to the auto-mitigation time based on different occurrences).

To estimate the volume reduction, noise reduction system 112 may replace the mitigation time of all incidents with the recommended auto-mitigation times and rerun the correlation engine. This recommendation may be suggested (e.g., to a user via configuration UI 116) if a volume reduction is predicted.

2. Example Architecture

Noise reduction system 112 may comprise both offline and online processing components. As part of offline processing, a job (e.g., a Map Reduce job) may the past incident data, aggregate it based on the monitor information, analyze the data, and generate recommendations for users to take actions to reduce or otherwise modify the incident volume. The workflow may trigger this offline processing and these recommendations may be stored in a database. In the online processing phase, the recommendations may be exposed through OData or REST APIs that are surfaced to clients or users to take actions.

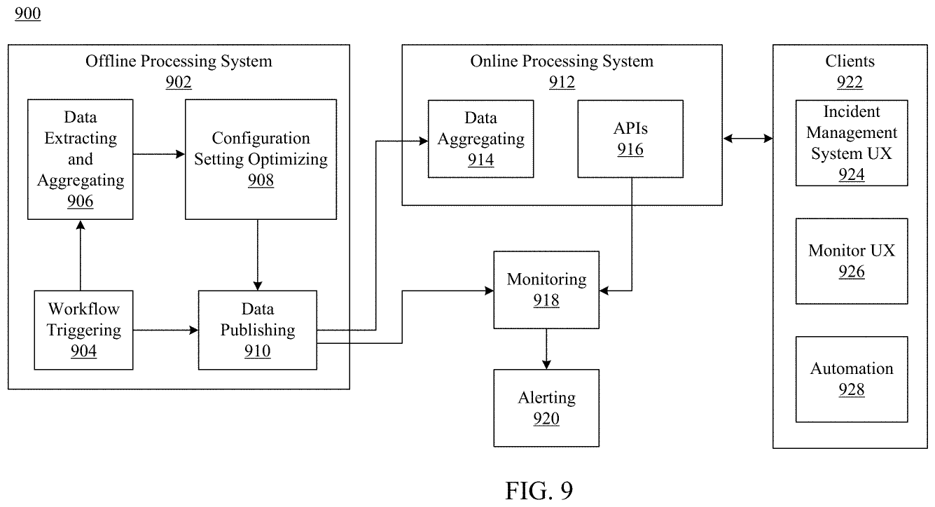

For example, FIG. 9 shows a block diagram of a system 900 that may be used to implement example embodiments described herein. System 900 shows an example implementation of monitoring system 104, incident management system 108, noise reduction system 112, configuration UI 116, and incident resolver UI 118. As shown in FIG. 9, system 900 includes an offline processing system 902, an online processing system 912, a monitoring component 918, and an alerting component 920, and clients 922. Offline processing system 902 includes components for data extracting and aggregating 906, configuration setting optimizing 908, workflow triggering 904, and data publishing 910. Online processing system 912 includes a data aggregating component 914 and one or more APIs 916. Clients 922 include an incident management user experience (UX) 924, a monitor UX 926, and an automation component 928. It is noted that system 900 need not include each component illustrated in FIG. 9, and/or may also include one or more other components not expressly illustrated. Components of system 900 will be described in greater detail below.

i. Offline Processing

Offline processing system 902 may implement certain features of noise reduction system 112. Noise reduction system 112 may be hosted on an on-demand analytics job service for big-data (e.g., using a Map Reduce framework), such as job service for large-scale batch computation and storage service. Noise reduction system 112 may be implemented using suitable language for filtering, combining and/or aggregating the data (e.g., SCOPE) and adding user defined operators to analyze and generate the recommendations (e.g., C#). As described herein, there may be several recommendation engines in the noise reduction system 112 which generate different recommendations on the configuration changes in the monitors and correlation rules.

The incident data may be obtained by loading the incidents for the past few days, extracting the necessary metadata such as monitor URLs from the unstructured text using a regular expression (e.g., regex), and then aggregating the information from different tables to the incident snapshot at the time of correlation using data extracting and aggregating component 906. The data may be passed through each of the recommendation engines implemented in configuration setting optimizing component 908, which analyze the data based on heuristics and statistics and generate meaningful inferences for suggesting new configuration settings. For each recommended action, the changes to the configuration settings which are reflected in the incidents and correlation rules may be made, and the incident volume reduction may be estimated by running the correlation simulation which mimics the correlation engine to have the incidents correlated. Finally, the recommended actions are provided (e.g., to a recommendation table as a structured stream for distributed data processing) if a potential volume reduction is predicted.

A workflow triggering component 904 may trigger this job at a specified frequency and once the job finishes, another job may be scheduled to publish this data via data publishing component 910 to a big data analytics cloud service (e.g., Microsoft® Azure Data Explorer (ADE)), or any other service used for interactive ad-hoc queries over structured, semi-structured, and unstructured data in near-real time. The workflow may handle the job failures using a retry mechanism. In implementations, monitors may also be setup to monitor the throughput and any job failures.

ii. Online Processing

Online processing 912 may involve reading the data from a cloud service (e.g., ADE) and aggregating the data based on one or more pivots (e.g., at monitor level, team level, etc.) using data aggregating component 914. APIs 916, such as OData or REST APIs, may be built on top of this to obtain the aggregated data and showcase it to clients 922 for the clients to take actions. Clients may include users of incident management UX 924, monitor UX 926, and/or one or more automation components 928.

Monitoring component 918 may be set up for the APIs to monitor the availability and latency of the service. An incident may be raised when the metrics do not meet the specified Service Level Objectives (SLO) (e.g., API availability is less than 99.99% over a ten minute window) and provided to alerting component 920.

D. Scalability

Noise reduction system 112 may process any number of incidents (e.g., hundreds of thousands to millions or more of incidents daily). In example implementations, the recommendation logic and the correlation simulation logic were transformed to make use of the MapReduce framework. Since the correlation simulation may be run multiple times to predict the estimated volume reduction for each recommendation, execution of the simulation may be desired to be highly optimized.

For a given set of incidents, the correlation simulation may identify a correlation rule and then find a matching active parent incident. To find a matching correlation rule, the incidents table and correlation table may be joined on the service name. The rules may then be filtered based on the spatial fields and the correlation rule with highest priority for an incident may be identified. Since the data is distributed by service, for each service it may take O(IC) time, where I is the number of incidents in a service and C is the number of correlation rules in a service (which is usually small). Thus, time complexity may be linear in the number of incidents.

To find a matching active parent incident, the state of each incident is maintained if it is parent or child. The incidents may be grouped based on correlation ID and environment. For each group, iterations are performed through the incidents, and for each incident, iterations are performed through each earlier incident to get the first active incident based on the spatial and temporal configuration settings.

An illustrative scalable algorithm is provided to find the matching active parent incident which takes O(I log(I)) time where I is the number of incidents in a service. The pseudo code for this algorithm is shown below:

| | Input: incidents=List<Incident> |
|---|---|
| | Output: incidents=List<Incident> with parent incident id |
| 1. | Let parentIncidents = Dictionary < matchFields, List <Incident >> // matchFields is |

a tuple representing the spatial configurations of an incident. There are 2^{#spatialConfigurations}
matchFields possible for an incident

| | |
|---|---|
| 2. | incidents = incidents.sort ( ) by incident's create date. |
| 3. | mitigatedIncidents = incidents.sort ( ) by incident's mitigated date |
| 4. | for incident in incidents do |

// Remove all the mitigated incidents so far from mitigatedIncidents and

parentIncidents

| | |
|---|---|
| 5. | while mitigatedIncidents.Count > 0 do |

| | |
|---|---|
| 6. | mitigatedIncident = mitigatedIncidents.ElementAt (0) |
| 7. | if incident's create date is ahead of the mitigatedIncident's mitigate date then |

| | |
|---|---|
| 8. | Remove the mitigatedIncident from mitigatedIncidents |
| 9. | Generate all 2^{#spatialConfigurations} matchFields for the mitigated incident. Let it |

be matchFieldlist

| | |
|---|---|
| 10. | for matchFields in matchFieldsList do |

| | |
|---|---|
| 11. | Remove the incident from parentIncidents [matchFields] list based on |

the binary search by comparing the incident id

| | |
|---|---|
| 12. | end |

| | |
|---|---|
| 13. | end |
| 14. | else |

| | |
|---|---|
| 15. | break |

| | |
|---|---|
| 16. | end |

| | |
|---|---|
| 17. | end |
| | // Find active parent incident based on the spatial and temporal matching criteria |
| 18. | Let the targetCreateDate = createDate.AddMinutes (−1 * creationDateWindow) |
| 19. | Generate matchFields tuple for this incident based on the matching correlation |

rule's matching criteria.

| | |
|---|---|
| 20. | Find the parent incident from parentIncidents [matchFields] list based on the left |

binary search by comparing the parent incident's createDate and current
incident's targetCreateDate.

| | |
|---|---|
| 21. | if an incident is found then |

| | |
|---|---|
| 22. | Set the parent incident id to the incident |

| | |
|---|---|
| 23. | end |
| 24. | else |

| | |
|---|---|
| 25. | Generate all 2^{#spatialConfigurations} matchFields for this incident. Let it be |

matchFieldsList

| | |
|---|---|
| 26. | for matchFields in matchFieldsList do |

| | |
|---|---|
| 27. | Add the current incident to parentIncidents [matchFields] list. |

| | |
|---|---|
| 28. | end |

| | |
|---|---|
| 29. | end |

| | |
|---|---|
| 30. | end |

As shown above, the illustrative algorithm initializes the dictionary for mapping the spatial configuration to the list of potential parent incidents. The illustrative algorithm sorts the incidents by the create date and also by the mitigate date. Incidents whose mitigation time is earlier than the current incident's create time are removed, as these incidents may not be a parent incident for any of the future incidents. For each of the removed incidents, all the spatial configuration combinations are obtained, and the incident is removed from the corresponding spatial configuration keys in the parent incidents dictionary. The illustrative algorithm also finds the target create date for the potential parent incident. The spatial configuration is generated based on the matching spatial fields in the correlation rule. The first parent incident within the target create date and the current incident's create date is identified. The illustrative algorithm shown above also sets the parent incident to the current incident. If no parent incident is found, all the spatial configuration combinations for the current incident are generated, and the current incident is added to the list of potential parent incidents dictionary. It is noted and understood that this algorithm is intended to be illustrative only, and other techniques for finding an active parent incident may also be implemented.

E. Evaluation

In this section, the potential noise reduction of each action type for high volume monitors is described. Furthermore, production case studies are presented for certain for action types with their corresponding noise reduction. Finally, the performance of the correlation simulation engine is described.

1. Volume Reduction

In evaluations, several million incidents generated in a 30-day interval were analyzed. It was observed that several monitors contributed to the majority of the incident volume, and a large number of monitors exhibited a relatively low volume. It may be difficult for on-call engineers to work on the incidents generated by the high volume monitors, which risks losing service-impacting incidents. Based on the analysis of these incidents, the system described herein was used to analyze the data and generate recommended actions that contributed to approximately a 63.5% volume reduction. In evaluations, a missing configuration setting action type contributed to a 51% reduction in incident volume, updating the spatial configuration settings contributed to an 8% reduction in incident volume, and the temporal configuration setting contributed to a 6.3% reduction in incident volume.

2. Production Case Studies

In sample case studies, monitors with relatively high volume were identified and recommended configuration settings were implemented for those monitors. Illustrative cases are described below in which noise reduction system 112 resulted in an overall decrease in incident volume.

In observations, services in which configuration settings were missing were evaluated. After adding the missing default correlation rules for services using techniques described herein, a large reduction in incident volume was observed by suppressing the duplicate incidents. In other observations, monitors where the spatial configuration settings were too granular, and therefore result in high volumes, were evaluated. After adding the spatial configuration settings using techniques described herein, a large reduction in incident volume was observed due to the correlating the related incidents. In other observations, monitors where temporal configuration settings were too granular, and therefore result in large volumes, were evaluated. After adding the creation window in the corresponding matching correlation rule using techniques described herein, a large reduction in incident volume was observed by suppressing the duplicate incidents.

3. Performance

In observations, the run-time performance of the correlation simulation engine was evaluated. For each incident volume size, several experiments were performed and the average runtime with the corresponding error bars were reported. It was observed that the correlation simulation engine scales for large datasets. Techniques described herein using noise reduction system 112 resulted in performance being stable for millions of incidents.

F. Additional Observations

This section summarizes additional observations from implementation of the configuration optimizer.

Test monitors in shadow-mode before production deployment. As new services launch and existing ones grow, new monitors may be created to track their performance and health metrics. However, given lack of run-time data to guide monitor settings, these new monitors can have sub-optimal or incorrect settings when deployed, risking high noisy incident volume. Noise reduction system 112 can address this challenge by running monitors in a shadow mode where their generated alerts are reported to noise reduction system 112, but not notify on-call engineers (e.g., alerts and/or incidents would not be provided to monitoring system 102 and/or incident management system 108). Based on actions recommended and evaluated by the noise reduction system 112, the monitor and/or correlation configurations can be set and then moved to production.

Transform common recommendations to default settings. For some configuration settings such as auto-mitigation time, multiple monitors may need to be set to the same value individually by team responsible for those monitors. In some implementations, recommended values using techniques described herein may be converted to default settings. For instance, the auto-mitigation setting may be changed to the default value of 10 times before the incident is mitigated. It was observed that such changes reduced the false mitigation of incidents and new duplicate incidents for many monitors so they can be set as default obviating the need to make individual changes for hundreds of thousands of monitors.

Improve usability by combining summary and detailed views. One challenge for showing recommendations using techniques described herein is to provide detailed data-driven insights without overwhelming users. In some implementations, summarized data related to recommended configuration changes was presented along with links to aggregated insights. In observations, it was observed that by first presenting summarized data with links to aggregated insights helped users to quickly understand the insights as well as analyze the full data if needed.

H. Concluding Remarks

A scalable noise reduction system 112 that provides recommendations with the estimated incident volume reduction is disclosed herein. Results showing the estimated volume reduction and case studies of how noise reduction system 112 helped reduce volume in production was presented. Further, the run-time performance of the noise reduction system 112 with different input sizes was presented. In some implementations, noise reduction system may run daily on millions of alerts to produce actionable insights that significantly reduce volume noise for services, thereby improving on-call productivity. Near-real time analysis may also be implemented on noise reduction system that allows users to interactively adjust the knobs to tune and view the corresponding volume reduction in real-time.

### IV. Example Computer System Implementation

Monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 may be implemented in hardware, or hardware combined with one or both of software and/or firmware. For example, monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 may be implemented as computer program code/instructions configured to be executed in one or more processors and stored in a computer readable storage medium.

Alternatively, monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 may be implemented as hardware logic/electrical circuitry.

For instance, in an embodiment, one or more, in any combination, of monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 10 depicts an exemplary implementation of a computing device 1000 in which embodiments may be implemented. For example, Monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 (and/or any of the steps of flowcharts 200, 400, and 500 described therein) may be implemented in one or more computing devices similar to computing device 1000 in stationary or mobile computer embodiments, including one or more features of computing device 1000 and/or alternative features. The description of computing device 1000 provided herein is provided for purposes of illustration, and is not intended to be limiting. Embodiments may be implemented in further types of computer systems, as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random-access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing any of the features of monitored resources 102, monitoring system 104, alerts 106, incident management system 108, incidents 110, noise reduction system 112, computing deice 114, configuration UI 116, incident resolver UI 118, data store 302, data retriever 306, workflow trigger 308, configuration optimizer 310, recommendation generator 312, configuration change 314, simulation engine 320, configuration change simulator 321, correlation simulator 322, noise evaluator 323, incident volume change 324, alerting system 326, multi-dimensional metrics 602, monitors 604, health system 606, correlation engine 608, correlation rules 610, incident creator 612, monitoring UI 700, correlation UI 800, offline processing system 902, online processing system 912, clients 922, flowchart 200, flowchart 400, and/or, flowchart 500 and/or further embodiments described herein.

A user may enter commands and information into computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1006 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium” are used to refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1000.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Further Example Embodiments

A system for identifying configuration parameters for generating issues in a computing environment is disclosed herein. The system includes: at least one processor circuit; and at least one memory that stores program code configured to be executed by the at least one processor circuit, the program code comprising: a data retriever configured to retrieve, from a data store, past incident data relating to past alerts in the computing environment; a configuration optimizer configured to: generate a configuration change based at least on an evaluation of the past incident data, predict an incident volume change under an assumption the configuration change is implemented, and provide the configuration change for implementation on an alerting system.

In one implementation of the foregoing system, the recommendation generator is further configured to identify a configuration setting with a missing value; and the configuration change comprises a replacement value for the configuration setting.

In another implementation of the foregoing system, the configuration change comprises a change in a spatial configuration setting, the spatial configuration setting identifying a parameter that identifies the origin of an alert occurring in the computing environment.

In another implementation of the foregoing system, the configuration change comprises a change to a temporal configuration setting of one a correlation rule or an automatic incident mitigator.

In another implementation of the foregoing system, the configuration change comprises a new correlation rule.

In another implementation of the foregoing system, the parameter comprises a plurality of dimensions used to identify an event occurring in the computing environment, and the change in the spatial configuration setting comprises a removal, modification, or addition of one of the dimensions.

In another implementation of the foregoing system, the configuration optimizer is configured to predict the incident volume change under the assumption the configuration change is implemented by simulating a correlation of the past alerts that implements the configuration change, and determining that the simulated correlation predicts a volume change.

In another implementation of the foregoing system, the configuration optimizer is configured to provide the configuration change for presentation on a user interface, along with an insight associated with the predicted incident volume change.

A method for identifying configuration parameters for generating issues in a computing environment. The method includes retrieving, from a data store, past incident data relating to past alerts in the computing environment; generating a configuration change based at least on an evaluation of the past incident data, predicting an incident volume change under an assumption the configuration change is implemented; and providing the configuration change for implementation on an alerting system.

In one implementation of the foregoing method, the generating the configuration change comprises identifying a configuration setting with a missing value, the configuration change comprising a replacement value for the configuration setting.

In another implementation of the foregoing method, the configuration change comprises a change in a spatial configuration setting, the spatial configuration setting identifying a parameter that identifies the origin of an alert occurring in the computing environment.

In another implementation of the foregoing method, the configuration change comprises a change to a temporal configuration setting of one a correlation rule or an automatic incident mitigator.

In another implementation of the foregoing method, the configuration change comprises a new correlation rule.

In another implementation of the foregoing method, the parameter comprises a plurality of dimensions used to identify an event occurring in the computing environment, and the change in the spatial configuration setting comprises a removal, modification, or addition of one of the dimensions.

In another implementation of the foregoing method, the method further includes simulating a correlation of the past alerts that implements the configuration change, and determining that the simulated correlation predicts a volume change.

In another implementation of the foregoing method, the providing the configuration change for presentation on a user interface comprises providing the configuration change along with an insight associated with the predicted incident volume change.

A computer-readable storage medium is disclosed herein. The computer-readable storage medium has program instructions recorded thereon that, when executed by at least one processor of a computing device, perform a method, the method comprising: retrieving, from a data store, past incident data relating to past alerts in the computing environment; generating a configuration change based at least on an evaluation of the past incident data; predicting an incident volume change under an assumption the configuration change is implemented; and providing the configuration change for implementation on an alerting system.

In one implementation of the foregoing computer-readable storage medium, the generating the configuration change comprises identifying a configuration setting with a missing value, the configuration change comprising a replacement value for the configuration setting.

In one implementation of the foregoing computer-readable storage medium, the configuration change comprises a change in a spatial configuration setting, the spatial configuration setting identifying a parameter that identifies the origin of an alert occurring in the computing environment.

In one implementation of the foregoing computer-readable storage medium, the method further includes: simulating a correlation of the past alerts that implements the configuration change, and determining that the simulated correlation predicts a volume change.

### VI. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A system for identifying configuration parameters for generating issues in a computing environment, comprising:
at least one processor circuit; and
at least one memory that stores program code configured to be executed by the at least one processor circuit, the program code comprising:
a data retriever configured to retrieve, from a data store, past incident data relating to past alerts in the computing environment;
a configuration optimizer configured to:
generate a configuration change based at least on an evaluation of the past incident data,
predict an incident volume change under an assumption the configuration change is implemented, and
provide the configuration change for implementation on an alerting system.

2. The system of claim 1, wherein the recommendation generator is further configured to identify a configuration setting with a missing value; and
wherein the configuration change comprises a replacement value for the configuration setting.

3. The system of claim 1, wherein the configuration change comprises a change in a spatial configuration setting, the spatial configuration setting identifying a parameter that identifies the origin of an alert occurring in the computing environment.

4. The system of claim 1, wherein the configuration change comprises a change to a temporal configuration setting of one a correlation rule or an automatic incident mitigator.

5. The system of claim 1, wherein the configuration change comprises a new correlation rule.

6. The system of claim 3, wherein the parameter comprises a plurality of dimensions used to identify an event occurring in the computing environment, and wherein the change in the spatial configuration setting comprises a removal, modification, or addition of one of the dimensions.

7. The system of claim 1, wherein the configuration optimizer is configured to predict the incident volume change under the assumption the configuration change is implemented by:
simulating a correlation of the past alerts that implements the configuration change, and
determining that the simulated correlation predicts a volume change.

8. The system of claim 1, wherein the configuration optimizer is configured to provide the configuration change for presentation on a user interface, along with an insight associated with the predicted incident volume change.

9. A method for identifying configuration parameters for generating issues in a computing environment, comprising:
retrieving, from a data store, past incident data relating to past alerts in the computing environment;
generating a configuration change based at least on an evaluation of the past incident data;
predicting an incident volume change under an assumption the configuration change is implemented;
and providing the configuration change for implementation on an alerting system.

10. The method of claim 9, wherein the generating the configuration change comprises identifying a configuration setting with a missing value, the configuration change comprising a replacement value for the configuration setting.

11. The method of claim 9, wherein the configuration change comprises a change in a spatial configuration setting, the spatial configuration setting identifying a parameter that identifies the origin of an alert occurring in the computing environment.

12. The method of claim 9, wherein the configuration change comprises a change to a temporal configuration setting of one a correlation rule or an automatic incident mitigator.

13. The method of claim 9, wherein the configuration change comprises a new correlation rule.

14. The method of claim 11, wherein the parameter comprises a plurality of dimensions used to identify an event occurring in the computing environment, and wherein the change in the spatial configuration setting comprises a removal, modification, or addition of one of the dimensions.

15. The method of claim 9, wherein the method further comprises:
simulating a correlation of the past alerts that implements the configuration change; and
determining that the simulated correlation predicts a volume change.

16. The method of claim 9, wherein the providing the configuration change for presentation on a user interface comprises providing the configuration change along with an insight associated with the predicted incident volume change.

17. A computer-readable storage medium having program instructions recorded thereon that, when executed by at least one processor of a computing device, perform a method, the method comprising:
retrieving, from a data store, past incident data relating to past alerts in the computing environment;
generating a configuration change based at least on an evaluation of the past incident data;
predicting an incident volume change under an assumption the configuration change is implemented;
and providing the configuration change for implementation on an alerting system.

18. The computer-readable storage medium of claim 17, wherein generating the configuration change comprises identifying a configuration setting with a missing value, the configuration change comprising a replacement value for the configuration setting.

19. The computer-readable storage medium of claim 17, wherein the configuration change comprises a change in a spatial configuration setting, the spatial configuration setting identifying a parameter that identifies the origin of an alert occurring in the computing environment.

20. The computer-readable storage medium of claim 17, wherein the method further comprises:
simulating a correlation of the past alerts that implements the configuration change; and
determining that the simulated correlation predicts a volume change.
